(19) United States
(12) Patent Application Publication
(10) Pub. No.: US 2012/0122333 A1
(43) Pub. Date: May 17, 2012

(54) Switching Device And Method For Fastening A Cable In Such Switching Device

(76) Inventors: Anders Eriksson, Vasteras (SE); David Karlén, Vasteras (SE)

(21) Appl. No.: 13/358,083

(22) Filed: Jan. 25, 2012

Related U.S. Application Data
(63) Continuation of application No. PCT/EP2009/060077, filed on Aug. 4, 2009.

(51) Int. Cl. H01R 13/62

(52) U.S. Cl. 439/345

(57) ABSTRACT

A switching device including a connection housing. The connection housing includes a mechanism for receiving a cable and clamping mechanism for clamping the cable, the cable including one or more strands. The connection housing further includes a space provided between a wall of the switching device and an end portion of the cable when inserted in the mechanism for reception, whereby the one or more strands of the end portion of the cable are arranged with a free end thereof having a larger dimension than the dimension of the one or more strands at the clamping means of the connection housing.

### CROSS-REFERENCE TO RELATED APPLICATIONS

The present Application is a continuation of pending International Patent Application PCT/EP2009/060077, filed on Aug. 4, 2009, which designates the United States and the content of which is incorporated herein by reference.

### FIELD OF THE INVENTION

The invention relates generally to the field of switching devices, such as mechanical and semiconductor switching devices.

### BACKGROUND OF THE INVENTION

There are numerous switching devices, for example mechanical and semiconductor ditto. A mechanical contactor is a mechanical switching device having only one position of rest, operated otherwise than by hand, capable of making, carrying and breaking currents under normal circuit conditions including operating overload conditions.

The mechanical contactor may be arranged to operate for example within a low voltage area, wherein a low voltage is commonly defined as up to about 1000 V ac or 1500 V dc. The mechanical contactor may be arranged to interrupt a current flowing in e.g. an electrical circuit or low voltage power distribution line in which it is inserted. Contactors wherein the switching is accomplished by means of electromagnetic interaction are widely used, although other switching techniques are available.

In order to ensure proper functioning of the contactor it is of great importance that ends of electrical conductors of the application at hand, e.g. the electrical circuit, are safely secured within the contactor. The ends of the electrical conductors have to be secured within the contactor in a way so as to fulfill certain requirements as defined in various standards. For example, the contactor has to be able to withhold the electrical conductor even at rather large pull-out forces acting on the electrical conductor.

A contactor not able to withhold the ends of the electrical conductors in a proper manner constitutes a potential safety hazard.

### SUMMARY OF THE INVENTION

In view of the above, it is an object of the present invention to provide a switching device having means for providing an increased security in regards of unintentional removal of a cable there from.

This object, among others, is achieved by a switching device as defined in the independent claim.

In accordance with the invention, a switching device is provided comprising a connection housing. The connection housing comprises means for receiving a cable and clamping means for clamping the cable. The cable comprises one or more strands. The connection housing further comprises a space provided between a wall of the switching device and an end portion of the cable when inserted in the means for reception. Thereby the one or more strands of the end portion of the cable are arranged with a free end thereof having a larger dimension than the dimension of the one or more strands at the clamping means of the connection housing. An increased pull-out force is thereby provided and unintentional extraction of electrical conductors is avoided.

In accordance with an embodiment of the invention, the space is created by designing the wall in a stepped manner. In an alternative embodiment, the space is created by designing the wall with a recess. In another alternative embodiment, the space is created by a recess in a cable clamp, the recess being located at a part of the cable clamp not bearing against the wall. The switching device can thus be designed with one of several possible designs for obtaining the desired space, enabling the choice of design in dependence on the application and requirements at hand.

Further features and advantages thereof will become clear upon reading the detailed description in conjunction with the accompanying drawings.

### BRIEF DESCRIPTION OF THE DRAWINGS

FIG. 1 illustrates a switching device in accordance with an embodiment of the present invention.

FIG. 2 illustrates a cable fastening portion of the switching device in accordance with the present invention.

FIGS. 3a and 3b illustrate exemplary design details of the switching device in accordance with the present invention.

FIGS. 4a and 4b illustrate schematically a comparison of a prior art solution and the solution in accordance with the present invention, respectively.

### DETAILED DESCRIPTION OF THE INVENTION

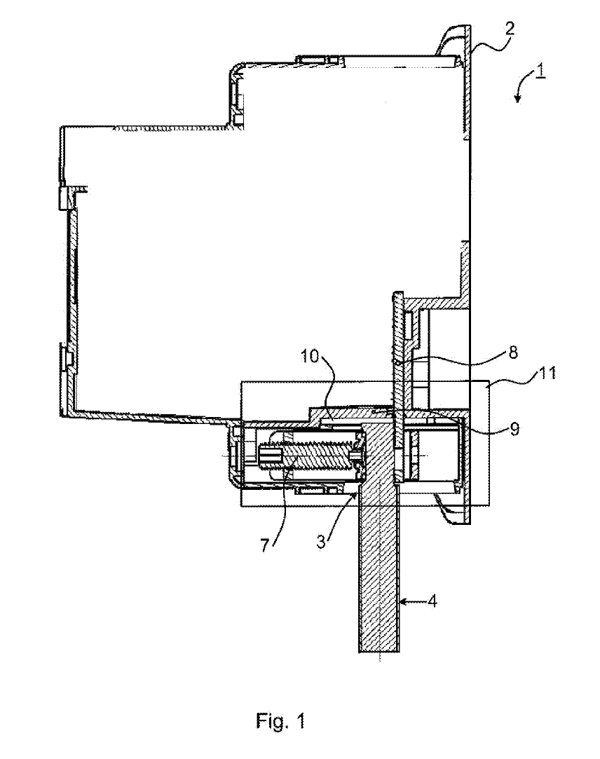

FIG. 1 illustrates a cross-sectional top view of a switching device 1 in accordance with an embodiment of the present invention. The switching device 1 may for example be a mechanical contactor or a soft starter. A soft starter is a switching device comprising semiconductor devices, such as thyristors, for accomplishing the switching, while a mechanical switching device is used for the switching of a mechanical contactor. The switching device 1 is in the following denoted simply contactor.

The contactor 1 comprises a contactor housing 2 made of a suitable electrically non-conducting material. It is noted that the contactor housing 2 may be an integrated part or comprise several detachable parts.

The contactor 1 further comprises a connection housing 11 for clamping a cable 4 inserted therein. The contactor housing 2 comprises, at the connection housing 11, one or more openings 3 for receiving a respective electrical conductor, in the following denoted cable 4.

In an embodiment, the connection housing 11 is an integrated part of the contactor housing 2. In another embodiment the connection housing 11 is detachable from the contactor housing 2, to be attached to the contactor housing 2 for example after a cable mounting has been initiated.

The contactor 1 comprises yet additional parts, for example devices necessary for accomplishing the switching action of the contactor 1, which devices could comprise electromagnets, coils, springs etc. However, as the invention is mainly concerned with the connection housing 11, such parts are not illustrated as they are not relevant for the present invention.

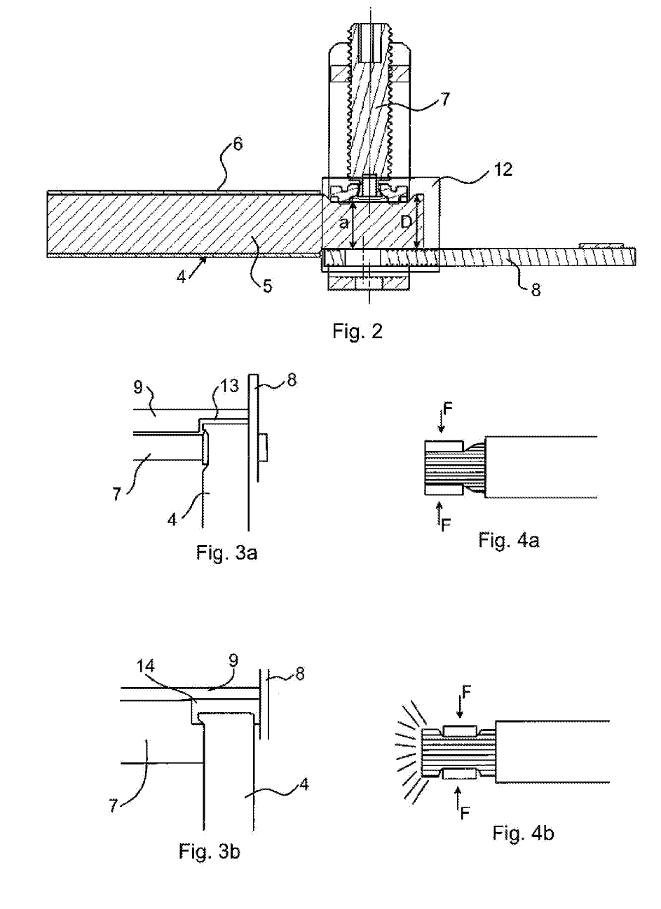

FIG. 2 illustrates a cable fastening portion of the contactor 1. The cable 4 typically comprises a conductor core, which in turn comprises a number of braided strands 5 made of an electrically conductive material. The conductor core is further typically surrounded by a suitable insulation 6.

At an end portion 12 of the cable 4, the insulation 6 has been peeled off for exposing the strands 5. The strands 5 are thereby in contact with a relay bar 8 of the contactor 1. A cable clamp 7 firmly clamps together the cable strands 5 and the relay bar 8 for accomplishing a reliable electrical contact. The cable clamp 7 is inserted into the connection housing 11 or comprises part of such connection housing 11.

The relay bar 8 is part of the contactor 1, and in embodiments wherein the connection housing 11 is a detachable part, the relay bar 8 constitutes, together with a wall 9 of the contactor housing 2, a receiving part for receiving the connection housing 11.

Reference is made again to FIG. 1, wherein the cable fastening portion of FIG. 2 is shown integrated with the contactor 1. The cable clamp 7 bears, at least partly, against the wall 9 of the contactor housing 2, either indirectly via some intermediate device (as shown in the FIG. 1) or directly (not illustrated). As mentioned above, the wall 9 comprises part of the contactor housing 2 against which the contactor housing 11 is attached, in case the contactor housing 11 is detachable. In case the contactor housing 11 is integrated with the contactor 1, the wall 9 constitutes part of the contactor housing 11.

The contactor 1 is designed such that a space 10, or distance, is provided between the end portion 12 of the cable 4 and the wall 9 of the contactor 1, when the cable 4 is inserted into the opening 3 of the connection housing 11. The end portion 12 of the cable 4 comprises strands 5 that are free from insulation 6. The space 10 is thus essentially to be understood as a distance between the end portion 12 of the cable 4 when inserted into the contactor 1 and the wall 9 of the contactor housing 2.

The space 10 can be provided by designing and/or dimensioning the wall 9 suitably. The wall 9 may for example be designed in a stepped manner, as illustrated in FIG. 1. In this embodiment, a first portion of the wall 9 bears, directly or indirectly as described earlier, against the cable clamp 7, the first portion thus supporting the cable clamp 7. A second portion of the wall 9 does not bear against the cable clamp 7 and is located at a different height in relation to the first portion of the wall 9, i.e. stepped in relation thereto, whereby the space 10 is created.

As another example, and with reference to FIG. 3a, the wall 9 could be designed with a recess 13 at the end of the wall 9 lying against the relay bar 8. The recess 13 then constitutes the space 10. Stated differently, the wall 9 in this embodiment is designed as a piece having two widths, a first width bearing (directly or indirectly) against the cable clamp 7 and a second width not bearing against the cable clamp 7, the first width being greater than the second width. The second width, i.e. the width of the wall 9 at which location the end portion 12 of the cable 4 is inserted, is dimensioned so as provide the desired space 10.

As yet another example, and with reference to FIG. 3b, the cable clamp 7 could alternatively be designed so as to provide the desired space 10. The cable clamp 7 could bear, again directly or indirectly, against the wall 9 only partly and be designed with a recess 14 which then constitutes the space 10. In this embodiment, the wall 9 may be a piece having an even width.

Further alternatives of designing the contactor 1 so as to provide the desired space 10 are conceivable. For example, the wall 9 as well as the cable clamp 7 could be designed with a recess, together forming the desired space 10.

In contrast to the invention, and in accordance with the prior art solutions, the strands of the cable bear against such wall of the contactor, when the cable is inserted into the contactor.

The space 10 provided in accordance with the invention enables the strands 5 of the cable 4 to swell, whereby an increased pull-out force is required for unintentionally removing the cable 4 from the contactor 1. The contactor 1 in accordance with the invention is thus improved in regards of the pull-out force required for unintentionally removing the cable 4. Further, the connection between the relay bar 8 and the cable 4 is also improved by means of the invention.

With reference again to FIG. 2, the strands 5 of the cable 4 are arranged with a free end thereof having a larger dimension D than the dimensions a of the strands 5 at the connection housing, at a site thereof where the cable clamp 7 clamps the strands 5 of the cable 4. That is, the cable end portion 12 comprising the exposed strands 5 does not have a uniform thickness, but has at least two different dimensions D and a, as illustrated in the FIG. 2 and FIGS. 3a and 3b.

FIG. 4a illustrates a prior art solution, wherein the strands of the cable end, are acted upon by a force F from a cable clamp at the end of the cable. FIG. 4b illustrates the solution in accordance with the present invention. As is illustrated in the figure, by providing the space 10 in accordance with the present invention, the strands 5 of the free end of cable 4 may spread and thereby reinforce the connection against pull-out when applying the force F from the cable clamp 7. When compared to the prior art solution of FIG. 4a, it is evident that an increased pull-out is provided by means of the invention. The cable 4 preferably comprises a number of strands 5, i.e. more than one, in order to obtain the greatest pull-out force resistance.

1. A switching device comprising a connection housing, said connection housing including means for receiving a cable and clamping means for clamping said cable, said cable including one or more strands, characterized in that said connection housing further comprises a space provided between a wall of said switching device and an end portion of said cable when inserted in said means for reception, whereby said one or more strands of said end portion of said cable are arranged with a free end thereof having a larger dimension than the dimension of said one or more strands at said clamping means of said connection housing.

2. The switching device as claimed in claim 1, wherein said end portion of said cable comprises strands free from insulation.

3. The switching device as claimed in claim 1, wherein said space is created by designing said wall in a stepped manner.

4. The switching device as claimed in claim 1, wherein said space is created by designing said wall with a recess.

5. The switching device as claimed in claim 1, wherein said connection housing comprises a cable clamp partly bearing against said wall, and wherein said space is created by a recess in said cable clamp located at a part thereof not bearing against said wall.

6. The switching device as claimed in claim 1, wherein said connection housing is detachable from said switching device and said wall is arranged to receive said connection housing.

7. The switching device as claimed in claim 1, wherein said means for reception of a cable comprises an opening arranged in said connection housing.

8. The switching device as claimed in claim 1, wherein said switching device comprises a mechanical contactor or soft starter.
